(19) United States
(12) Patent Application Publication
(10) Pub. No.: US 2023/0193471 A1
(43) Pub. Date: Jun. 22, 2023

(54) ELECTROLESS PLATING METHODS AND RELATED ARTICLES

(71) Applicant: Xerox Corporation, Norwalk, CT (US)

(72) Inventors: Nan-Xing HU, Oakville (CA); Yulin WANG, Oakville (CA); Edward G. ZWARTZ, Mississauga (CA)

(73) Assignee: Xerox Corporation, Norwalk, CT (US)

(21) Appl. No.: 17/559,691

(22) Filed: Dec. 22, 2021

(51) Int. Cl. C23C 18/16; C23C 18/20; C23C 18/34

(52) U.S. Cl. CPC C23C 18/1641; C23C 18/1689; C23C 18/2006; C23C 18/34

(57) ABSTRACT

Two-dimensional conductive nanoparticles may facilitate preparation of metal coatings prepared via electroless plating. Articles having a metal coating may comprise: a polymer body, and a metal coating on at least a portion of an outer surface of the polymer body. The metal coating comprises a plating metal and overlays a plurality of two-dimensional conductive nanoparticles and a catalyst metal.

### FIELD

The present disclosure relates to articles having a metallized surface and electroless plating methods related thereto.

### BACKGROUND

Additive manufacturing, also known as three-dimensional (3-D) printing, is a rapidly growing technology area. Although additive manufacturing has traditionally been used for rapid prototyping activities, this technique is being increasingly employed for producing commercial and industrial parts (objects) in any number of complex shapes. Additive manufacturing processes operate by layer-by-layer deposition of either 1) a stream of molten printing material obtained from a continuous filament or 2) powder particles of a printing material. The layer-by-layer deposition usually takes place under control of a computer to deposit the printing material in precise locations based upon a digital three-dimensional “blueprint” (a computer-aided design model) of the part to be manufactured, with consolidation of the printing material taking place in conjunction with deposition to form the printed part. The printing material forming the body of a printed part may be referred to as a “build material” herein.

Additive manufacturing processes employing a stream of molten printing material for part formation typically utilize a thermoplastic polymer filament as a source of the molten printing material. Such additive manufacturing processes are sometimes referred to as “fused deposition modeling” or “fused filament fabrication” processes.

Additive manufacturing processes employing powder particles of a printing material may perform directed heating in selected locations of a particulate (powder) bed following printing material deposition to promote localized coalescence of the powder particles into a consolidated part having a polymer body. Techniques suitable for promoting consolidation of powder particles to form a consolidated part include, for example, Powder Bed Fusion (PBF), selective laser sintering (SLS), Electron Beam Melting (EBM), Binder Jetting and Multi-Jet Fusion (MJF).

Parts manufactured by fused filament fabrication and through particle consolidation may appear rather similar to one another on the macroscale, but they may be distinguishable on the microscale. Printed parts made through particle consolidation may show evidence of grain boundaries throughout substantially the entirety of the part. Depending on the extent of particle consolidation that takes place, the grain boundaries may be more observable in some cases than in others. Surface roughness may also be present in printed parts formed through particle consolidation. Printed parts made by fused filament fabrication, in contrast, do not have uniformly distributed grain boundaries. Along a printed line formed from a molten polymer in fused filament fabrication, there are substantially no grain boundaries, but there may be evidence of incomplete consolidation between adjacent printed lines or layers. Both types of printed parts may be distinguishable from molded, cast, or machined parts produced from a bulk thermoplastic polymer or polymer melt.

In some instances, it can be desirable for additional functional characteristics to be present upon the surface of an additively manufactured part. Metal coatings may be present upon at least a portion of the outer surface of an additively manufactured part to convey both aesthetic and functional benefits including, for example, improved strength, electrical conductivity, heat and chemical resistance, or electromagnetic shielding properties, for instance. Metals sometimes may not adhere effectively to a polymer surface. Although metal plating methods having been developed for coating extruded or injection molded polymer parts with metal, these approaches may be less effective for additive manufactured parts produced through particulate consolidation, primarily due to their surface roughness.

### SUMMARY

The present disclosure relates to articles having a metallized surface and electroless plating methods related thereto.

In some embodiments, the present disclosure provides articles having a metal coating. The articles comprise: a polymer body; and a metal coating on at least a portion of an outer surface of the polymer body, the metal coating comprising a plating metal and overlaying a plurality of two-dimensional conductive nanoparticles and a catalyst metal.

In other embodiments, the present disclosure provides methods for forming a metal coating on an article. The methods comprise: providing a polymer body comprising a plurality of two-dimensional conductive nanoparticles and a catalyst metal upon an outer surface of the polymer body; and performing electroless plating upon the outer surface of the polymer body using a plating metal precursor to form a metal coating upon the outer surface of the polymer body, the metal coating comprising a plating metal and overlaying the plurality of two-dimensional conductive nanoparticles and the catalyst metal.

### BRIEF DESCRIPTION OF THE DRAWINGS

The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a flow chart of a non-limiting example method for forming metallized polymer bodies.

FIG. 2 is a flow chart of another non-limiting example method for forming metallized polymer bodies.

FIG. 3 is a flow chart of a non-limiting example melt emulsification method for producing polymer particles.

FIGS. 4A and 4B are SEM images of polyamide particles produced by melt emulsification where a silica particle emulsion stabilizer was used.

FIGS. 5A and 5B are SEM images of the polyamide particles of FIGS. 4A and 4B after treatment to remove the silica nanoparticles.

### DETAILED DESCRIPTION

The present disclosure relates to articles having a metallized surface and electroless plating methods related thereto.

As discussed above, it may be difficult to introduce a metal coating onto a polymer surface, particularly a polymer surface produced through consolidation of polymer particles comprising a thermoplastic polymer. In response to the foregoing, the methods described herein utilize two-dimensional conductive nanoparticles to facilitate electroless plating of a metal coating on a polymer body. The two-dimensional conductive nanoparticles may be present upon or introduced to at least a portion of the outer surface of an article produced by additive manufacturing to facilitate metal deposition thereon. Advantageously, the two-dimensional conductive nanoparticles may be introduced to the surface of the article after additive manufacturing takes place, or the two-dimensional conductive nanoparticles may be incorporated upon or within polymer particles used to form the article. Once two-dimensional conductive nanoparticles are present upon at least a portion of an outer surface of the article (or are exposed to the surface of the polymer body when residing therein), catalyst metal may be deposited upon the two-dimensional conductive nanoparticles, and electroless plating may then take place thereafter. The two-dimensional conductive nanoparticles may provide a large surface area for deposition of catalyst metal to take place, and electrical conductivity of the two-dimensional conductive nanoparticles may facilitate reduction of the catalyst metal as well. Without being bound by any theory or mechanism, the electrical conductivity of the two-dimensional conductive nanoparticles may work in conjunction with the catalyst metal to provide an additional conductive surface for electroless plating to take place. Thus, the two-dimensional conductive nanoparticles may facilitate more efficient use of the catalyst metal during electroless plating. Lowering the amount and/or increasing the usage efficiency of the catalyst metal may be desirable, given the expense of Pd and other types of noble metal catalysts.

The two-dimensional conductive nanoparticles may facilitate deposition of the catalyst metal upon the outer surface of an article having a polymer body, promote formation of a more complete metal coating upon the outer surface, increase adherence of the metal coating onto the outer surface, and/or decrease the loading of catalyst metal needed to facilitate formation of a continuous or near-continuous metal coating upon at least a portion of the outer surface. Accordingly, the outer surface may have a thicker, more robust, and/or more complete metal coating when two-dimensional conductive nanomaterials are used compared to when they are not. Further advantageously, the two-dimensional conductive nanoparticles may facilitate metal deposition upon a polymer surface having high surface roughness, such as may be found in articles produced through particle consolidation techniques.

As a further advantage, the thermoplastic polymer component of the articles undergoing electroless plating according to the disclosure herein may be varied to provide desired properties needed for a given application. For example, the thermoplastic polymer of polymer particles suitable for additive manufacturing techniques may be chosen to have desired properties suitable for a given application, such as high impact strength and/or flexibility. A wide variety of thermoplastic polymers may be utilized for forming polymer particles in a narrow size range and with desired geometry, which may undergo subsequent metallization after forming a polymer article, as discussed in greater detail hereinafter. Moreover, two-dimensional conductive nanoparticles may be readily incorporated upon polymer particles comprising a thermoplastic polymer, as also discussed subsequently. Although advantageous for forming a metal coating upon polymer bodies comprising a thermoplastic polymer, it is to be appreciated that the concepts of the present disclosure may also be used to form a metal coating upon non-thermoplastic polymers as well, such as thermosetting polymers or epoxies.

### Definitions and Test Methods

Numerical ranges used herein include the numbers recited in the range. For example, the numerical range “from 1 wt % to 10 wt %” includes 1 wt % and 10 wt % within the recited range.

As used herein, the term “conductive” refers to a substance having electrical conductivity.

As used herein, the term “immiscible” refers to a mixture of components that, when combined, form two or more phases that have less than 5 wt % solubility in each other at ambient pressure and at room temperature or the melting point of the component if it is solid at room temperature. For example, polyethylene oxide having 10,000 g/mol molecular weight is a solid at room temperature and has a melting point of 65° C. Therefore, said polyethylene oxide is immiscible with a material that is liquid at room temperature if said material and said polyethylene oxide have less than 5 wt % solubility in each other at 65° C.

A “polymer” has two or more of the same or different mer units. A “homopolymer” is a polymer having mer units that are the same. The term “polymer” as used herein includes, but is not limited to, homopolymers, copolymers, terpolymers, and the like. The term “polymer,” as used herein, also includes impact, block, graft, random, and alternating copolymers. The term “polymer” further includes all possible geometrical configurations unless otherwise specifically stated. Such configurations may include isotactic, syndiotactic, and random symmetries.

As used herein, the term “thermoplastic polymer” refers to a plastic polymer material that softens and hardens reversibly on heating and cooling. Thermoplastic polymers encompass thermoplastic elastomers.

As used herein, the term “elastomer” refers to a copolymer comprising a crystalline “hard” section and an amorphous “soft” section. In the case of a polyurethane, the crystalline section may include a portion of the polyurethane comprising the urethane functionality and optional chain extender group, and the soft section may include the polyol, for instance.

As used herein, the term “nanoparticles” refers to a particulate material having a particle size ranging from about 1 nm to about 500 nm.

As used herein, the term “oxide” refers to both metal oxides and non-metal oxides. For purposes of the present disclosure, silicon is considered to be a metal.

An “olefin,” alternatively referred to as “alkene,” is a linear, branched, or cyclic compound of carbon and hydrogen having at least one double bond. Further, when a polymer is referred to as “comprising an olefin” or as a “polyolefin,” the olefin present in the polymer is the polymerized form of the olefin.

As used herein, when a polymer is referred to as “comprising, consisting of, or consisting essentially of” a monomer, the monomer is present in the polymer in the polymerized form of the monomer or is the derivative form of the monomer. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer.

As used herein, the term “embed” relative to particles (e.g., nanoparticles) and a surface of a polymer particle refers to the particle being at least partially extended into the surface of the polymer particle such that polymer is in contact with the nanoparticle to a greater degree than would be if the nanoparticle were simply laid on the surface of the polymer particle, thereby contacting the surface tangentially.

As used herein, D₁₀, D₅₀, D₉₀, and diameter span are primarily used herein to describe particle sizes. As used herein, the term “D₁₀” refers to a diameter below which 10% (on a volume-based distribution, unless otherwise specified) of the particle population is found. As used herein, the terms “D₅₀,” “average particle diameter,” and “average particle size” refer to a diameter below which 50% (on a volume-based median average, unless otherwise specified) of the particle population is found. As used herein, the term “D₉₀” refers to a diameter below which 90% (on a volume-based distribution, unless otherwise specified) of the particle population is found. As used herein, the terms “diameter span,” “span” and “span size,” when referring to diameter, provides an indication of the breadth of the particle size distribution and is calculated as (D₉₀−D₁₀)/D₅₀.

Particle diameters and particle size distributions are determined by light scattering techniques using a Malvern MASTERSIZER™ 3000. For light scattering techniques, the control samples were glass beads with a diameter within the range of 15 μm to 150 μm under the tradename Quality Audit Standards QAS4002™ obtained from Malvern Analytical Ltd. Samples were analyzed as dry powders, unless otherwise indicated. The particles analyzed were dispersed in air and analyzed using the AERO S™ dry powder dispersion module with the MASTERSIZER™ 3000. The particle sizes were derived using instrument software from a plot of volume density as a function of size.

As used herein, when referring to sieving, pore/screen sizes are described per U.S.A. Standard Sieve (ASTM E11-17).

As used herein, the term “circularity” refers to how close a particle is to a perfect sphere. To determine circularity, optical microscopy images using flow particle imaging are taken of the particles. The perimeter (P) and area (A) of the particle in the plane of the microscopy image is calculated (e.g., using a SYSMEX FPIA 3000 particle shape and particle size analyzer, available from Malvern Instruments). The circularity of the particle is CEA/P, where CEA is the circumference of a circle having the area equivalent to the area (A) of the actual particle. Herein, the circularity is based on three runs through a SYSMEX FPIA 3000 particle shape and particle size analyzer, where 6,000 to 10,000 particles are analyzed per run. The reported circularity is the median average circularity based on particle number. In the analysis, a threshold for distinguishing the greyscale levels between the background pixels and the particle pixels (e.g., to correct for non-uniform illumination conditions) was set at 90% of the background modal value.

As used herein, the term “shear” refers to stirring or a similar process that induces mechanical agitation in a fluid.

As used herein, the term “aspect ratio” refers to length divided by width, wherein the length is greater than the width.

The melting point of a polymer, unless otherwise specified, is determined by ASTM E794-06(2018) with 10° C./min ramping and cooling rates.

The softening temperature or softening point of a polymer, unless otherwise specified, is determined by ASTM D6090-17. The softening temperature can be measured by using a cup and ball apparatus available from Mettler-Toledo using a 0.50 gram sample with a heating rate of 1° C./min.

The crystallization temperature is the temperature at which a polymer crystallizes (i.e., solidifies) into a structured form, naturally or in an artificially initiated process, wherein atoms or molecules are highly organized into a crystal. The crystallization temperature may be measured by Differential Scanning calorimetry (DSC). DSC provides a rapid method for determining polymer crystallinity based on the heat required to melt the polymer. The crystallization temperature (° C.) is measured according to ASTM E794-06(2018) with 10° C./min ramping and cooling rates where the crystallization temperature is determined based on the second heating and cooling cycle.

The crystallinity (%) of a polymer, unless otherwise specified, is determined by ASTM D3418-15. For crystallinity calculations, a 100% crystalline TPU is considered to have an enthalpy of 196.8 J/g.

Mw is the weight-average molecular weight. Unless otherwise noted, Mw has units of g/mol or kDa (1,000 g/mol=1 kDa) and is measured by gel permeation chromatography.

The melt flow index (MFI) is the measure of resistance to flow of polymer melt under defined set of conditions (unit: g/10 min) and is measured by ASTM 1238-20 Standard Procedure A at 195° C. using a 2 mm orifice and a 2.16 kg load. Being a measure at low shear rate condition, MFI is inversely related to molecular weight of the polymer.

As used herein, “tensile modulus” (MPa) of a solid material is a mechanical property that measures its stiffness. It is defined as the ratio of its tensile stress (force per unit area) to its strain (relative deformation) when undergoing elastic deformation. It can be expressed in Pascals or pounds per square inch (psi). ASTM D638-14 can be used to determine tensile modulus of a polymer.

Angle of repose is a measure of the flowability of a powder. Angle of repose measurements were determined using a Hosokawa Micron Powder Characteristics Tester PT-R using ASTM D6393-14 “Standard Test Method for Bulk Solids” Characterized by Carr Indices.”

Aerated density (ρₐₑᵣ) is measured per ASTM D6393-14.

Bulk density (ρ_{bulk}) is measured per ASTM D6393-14.

Tapped density (ρₜₐₚ) is measured per ASTM D6393-14.

Hausner ratio (Hᵣ) is a measure of the flowability of a powder and is calculated by Hᵣ=ρₜₐₚ/ρ_{bulk}, where ρ_{bulk} is the bulk density per ASTM D6393-14 and ρₜₐₚ is the tapped density per ASTM D6393-14.

As used herein, viscosity of carrier fluids are the kinematic viscosity values at 25° C., unless otherwise specified, and are measured per ASTM D445-19. For commercially procured carrier fluids (e.g., polydimethylsiloxane oil (PDMS)), the kinematic viscosity data cited herein was provided by the manufacturer, whether measured according to the foregoing ASTM or another standard measurement technique.

### Articles Having a Metal Coating and Electroless Plating Methods to Produce Articles Having a Metal Coating

Articles of the present disclosure may comprise a polymer body, such as a polymer body comprising a thermoplastic polymer, and a metal coating on at least a portion of an outer surface of the polymer body. The metal coating comprises a plating metal and overlays a plurality of two-dimensional conductive nanoparticles and a catalyst metal. The catalyst metal and the plating metal may be the same or different. The polymer body may be an additively manufactured polymer body produced by consolidation of polymer particles, such as thermoplastic polymer particles, as discussed hereinbelow.

Optionally, an adhesion promotor may be further added to enhance the extent of adhesion between the two-dimensional conductive nanoparticles and the polymer body. Illustrative examples of adhesion promotors may include, but are not limited to, a polydopamine or a silane coupling agent containing functional groups that bond with both polymer resin and two-dimensional conductive nanoparticles. Specific examples of silane coupling agents may include an organic compound containing a hydrolyzable silane group and a functional group, such as an amine, a nitrile, an epoxide, a vinyl, a thiol, a phosphonate, or the like. Suitable adhesion promotors may be separately applied to the surface of the polymer body by known coating techniques. Alternately, the adhesion promoter may be applied along with the two-dimensional conductive nanoparticles through exposing the polymer body to a mixture containing the two-dimensional conductive nanoparticles and the adhesion promoter. Still further alternately, an adhesion promoter may be included with polymer particles used to form the polymer body. Most two-dimensional conductive nanoparticles contain one or more types of functional groups suitable to react with complementary functional groups upon a silane coupling agent, particularly the silane group, thereby facilitating adhesion when both substances are present.

Electroless plating techniques may build up the metal coating upon the outer surface of the polymer body. Before conducting electroless plating, the two-dimensional conductive nanoparticles may be incorporated upon the outer surface, either as part of an additive manufacturing process, and/or separately following formation of the polymer body. Alternately, the two-dimensional conductive nanoparticles may be present within the polymer body, such that at least a portion of the two-dimensional conductive nanoparticles are exposed at the surface of the polymer body. Catalyst metal may then be deposited upon the two-dimensional conductive nanoparticles, and electroless plating may take place thereafter to deposit a plating metal. Alternately, the two-dimensional conductive nanoparticles and the catalyst metal may be deposited together (simultaneously). As such, the two-dimensional conductive nanoparticles and catalyst metal may be localized at an interface of the metal coating and the outer surface of the polymer body. The catalyst metal and the plating metal may both be transition metals, which may differ from one another or be the same. The two-dimensional conductive nanoparticles and the catalyst metal need not necessarily define a continuous layer upon the polymer body. Additional details concerning incorporation of the two-dimensional conductive nanoparticles upon the polymer body and electroless plating are provided hereinafter.

After electroless plating takes place to metallize the outer surface of the polymer body, additional electroplating may take place on the metal coating deposited under electroless plating conditions, if desired. Electroplating may be conducted to extend the thickness of the metal coating up to about 50 μm.

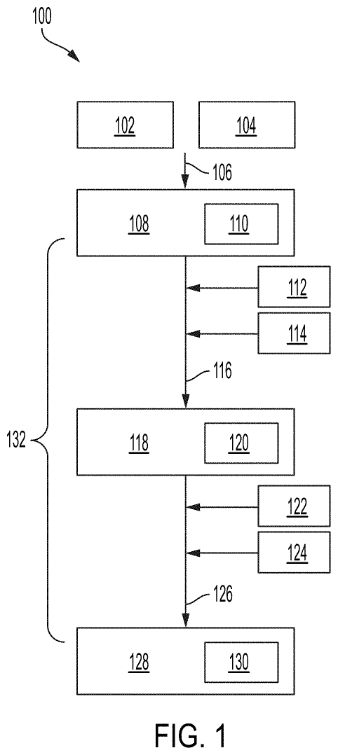

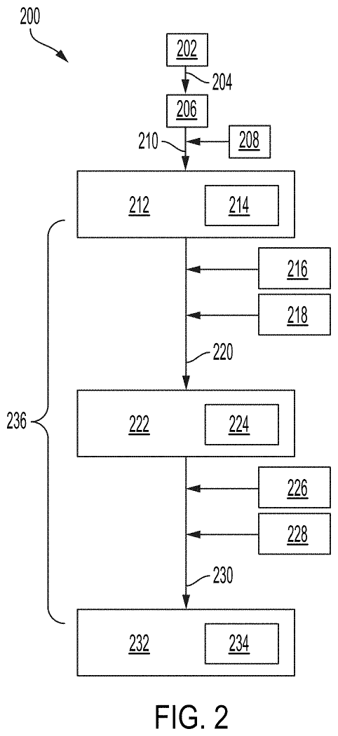

FIGS. 1 and 2 are flow charts of non-limiting example methods for forming articles having a metal coating, according to the disclosure herein.

In method 100 of FIG. 1, first polymer particles 102 and optionally second polymer particles 104 are used to form at least a portion of additively manufactured polymer body 108 by particle consolidation method 106 (e.g., PBF, SLS, EBM, binder jetting, or MJF). First polymer particles 102 comprise polymer particles having a two-dimensional conductive nanoparticle coating on at least a portion of an outer surface of the polymer particles. Second polymer particles 104 comprise polymer particles that do not comprise a two-dimensional conductive nanoparticle coating and are otherwise the same as or different than (e.g., according to composition, shape, and/or other physical properties) first polymer particles 102.

The resultant polymer body 108 obtained by additive manufacturing comprises one or more outer surfaces having two-dimensional conductive nanoparticle layer 110 thereon because of the presence of first polymer particles 102 in particle consolidation method 106.

When using first polymer particles 102 and second polymer particles 104 in combination with one another (if second polymer particles are used), a mass ratio of first polymer particles 102 to second polymer particles 104 may be about 10:1 to about 1:100, or about 10:1 to about 1:100, or about 10:1 to about 1:100, or about 10:1 to about 1:100, or about 10:1 to about 1:100. The mass ratio between first polymer particles 102 and second polymer particle 104 may be varied, for example, to promote effective particle consolidation, possibly in response to the amount of two-dimensional conductive nanoparticles present upon first polymer particles 102. In various embodiments, first polymer particles 102 and second polymer particles 104 may comprise one or more thermoplastic polymers.

Polymer body 108 then undergoes electroless plating 132. Electroless plating 132 includes a first step in which catalyst metal is deposited upon at least a portion of the outer surface of polymer body 108. In particular, at least a portion of two-dimensional conductive nanoparticle layer 110 is exposed 116 to catalyst metal precursor 112 (e.g., a first transition metal compound) and first reducing agent 114, which may occur simultaneously or stepwise. For example, at least a portion of two-dimensional conductive nanoparticle layer 110 may first be contacted with catalyst metal precursor 112 so that at least a portion of catalyst metal precursor 112 is disposed on two-dimensional conductive nanoparticle layer 110. Thereafter, catalyst metal precursor 112 may be exposed to first reducing agent 114 to cause catalyst metal precursor 112 to form catalyst metal. Exposure of catalyst metal precursor 112 to first reducing agent 114 may occur simultaneously or stepwise, and one or more times. The resultant product is polymer body 118 comprising one or more outer surfaces having layer 120 comprising the two-dimensional conductive nanoparticles and the catalyst metal.

In a second step of electroless plating 132, at least a portion of layer 120 upon polymer body 118 may then be exposed 126 to electroless plating conditions by contacting plating metal precursor 122 (e.g., a second transition metal compound different than catalyst metal precursor 112) and second reducing agent 124 to cause a plating metal to deposit on layer 120 in proximity to the catalyst metal, thereby forming metallized polymer body 128 comprising one or more outer surfaces having metal coating 130 thereon. Metal coating 130 comprises the plating metal and overlays the two-dimensional conductive nanoparticles and the catalyst metal (i.e., layer 120). First reducing agent 114 and second reducing agent 124 may be the same or different. Metal coating 130 may cover a portion of the outer surface of metallized polymer body 128 or the entirety of the outer surface of metallized polymer body 128.

Accordingly, such methods of the present disclosure may comprise providing a polymer body produced by consolidation of polymer particles, optionally polymer particles comprising a thermoplastic polymer, and a plurality of two-dimensional conductive nanoparticles upon an outer surface thereof (or within the thermoplastic polymer), in which at least a portion of the two-dimensional nanoparticles reside upon an outer surface of the polymer body; depositing a catalyst metal upon at least a portion of the outer surface of the polymer body; and performing electroless plating upon the outer surface of the polymer body using a plating metal precursor to form a metal coating upon the outer surface of the polymer body. The metal coating may overlay the two-dimensional conductive nanoparticles and the catalyst metal. The catalyst metal and the plating metal may differ from one another or be the same.

In method 200 of FIG. 2, polymer particles 202 comprising a thermoplastic polymer are used to form at least a portion of polymer body 206 by particle consolidation method 204 (e.g., PBF, SLS, EBM, binder jetting, or MJF). Thereafter, an outer surface of polymer body 206 is exposed 210 to two-dimensional conductive nanoparticles 208 to form polymer body 212 having two-dimensional conductive nanoparticle layer 214 thereon.

Polymer body 212 then undergoes electroless plating 236. Electroless plating 236 includes a first step where at least a portion of two-dimensional conductive nanoparticle layer 214 is exposed 220 to catalyst metal precursor 216 (e.g., a first transition metal compound) and a first reducing agent 218, which may occur simultaneously or stepwise. For example, at least a portion of two-dimensional conductive nanoparticle layer 214 may first be contacted with catalyst metal precursor 216 to dispose catalyst metal precursor 216 on at least a portion of two-dimensional conductive nanoparticle layer 214. Thereafter, catalyst metal precursor 216 may be exposed to first reducing agent 218 to cause catalyst metal precursor 216 to form catalyst metal. Exposure of catalyst metal precursor 216 and first reducing agent 218 may occur simultaneously or stepwise, and occur one or more times. The resultant polymer body 222 comprises one or more surfaces having layer 224 comprising the two-dimensional conductive nanoparticles and the catalyst metal.

In a second step of electroless plating 236, at least a portion of layer 224 of polymer body 222 may then be exposed 230 to electroless plating conditions by contacting plating metal precursor 226 (e.g., a second transition metal compound the same as or different than catalyst metal precursor 216) and second reducing agent 228 to cause plating metal to deposit on layer 224 in proximity to catalyst metal, thereby forming metallized polymer body 232 comprising one or more surfaces having metal coating 234 thereon. Metal coating 234 comprises the plating metal and overlays the two-dimensional conductive nanoparticles and the catalyst metal. Metal coating 234 may be continuous or discontinuous upon polymer body 234. First reducing agent 218 and second reducing agent 228 may be the same or different. Metal coating 234 may cover a portion of the outer surface of metallized polymer body 232 or the entirety of the outer surface of metallized polymer body 232.

Accordingly, methods of the present disclosure may comprise providing a polymer body, optionally comprising a thermoplastic polymer; depositing a plurality of two-dimensional conductive nanoparticles upon at least a portion of an outer surface of the polymer body; depositing a catalyst metal upon at least a portion of the outer surface of the polymer body; and performing electroless plating upon the outer surface of the polymer body using a plating metal precursor to form a metal coating upon the outer surface of the polymer body. The catalyst metal and the plating metal may differ from one another or be the same. Preferably, the polymer body is an additively manufactured polymer body produced by consolidation of polymer particles. The two-dimensional conductive nanoparticles and the catalyst metal precursor may be deposited in any order, including simultaneously.

In yet another alternative embodiment, a hybrid of FIGS. 1 and 2 (or variations thereof) may be performed where a polymer body is produced with polymer particles having a first two-dimensional conductive nanoparticle coating thereon, and the polymer body is then further coated with second two-dimensional conductive nanoparticles, where the first and second two-dimensional conductive nanoparticles may be the same or different. Catalyst metal deposition and electroless plating may then be performed.

Moreover, while the methods described herein disclose electroless plating of a surface having two-dimensional conductive nanoparticles thereon, it should be noted that the methods are not limited solely to electroless plating of such surfaces. For example, electroless plating of additional surfaces not having two-dimensional conductive nanoparticles thereon is also contemplated in the present disclosure.

More generally, methods of the present disclosure may comprise providing a polymer body comprising a plurality of two-dimensional conductive nanoparticles and a catalyst metal upon an outer surface of the polymer body; and performing electroless plating upon the outer surface of the polymer body using a plating metal precursor to form a metal coating upon the outer surface of the polymer body. The metal coating comprises a plating metal and overlays the plurality of two-dimensional conductive nanoparticles and the catalyst metal.

In the disclosure herein, providing the polymer body may comprise depositing the plurality of two-dimensional conductive nanoparticles upon an outer surface of a plurality of polymer particles lacking a surface coating, preferably thermoplastic polymer particles. Alternately, the polymer body may be formed by consolidation of a plurality of thermoplastic polymer particles, which may or may not have a coating comprising the two-dimensional conductive nanoparticles. Optionally, the plurality of two-dimensional conductive nanoparticles may be deposited upon an outer surface of a plurality of polymer particles lacking a surface coating.

The polymer particles used in the methods described herein may be obtained from any suitable source and comprise a thermoplastic polymer. For example, the polymer particles may be produced by more methods including cryomilling methods, melt emulsification methods, emulsion polymerization methods, or other techniques. Suitable melt emulsification techniques are described in more detail hereinbelow.

The thermoplastic polymer of the polymer particles may be chosen based upon the end-use application of the article having a metallized surface. Suitable thermoplastic polymers may include, but are not limited to, thermoplastic polyolefins, polyamides, polyurethanes, polyacetals, polycarbonates, polybutylene terephthalate (PBT), polyethylene terephthalate (PET), polyethylene naphthalate (PEN), polytrimethylene terephthalate (PTT), ethylene vinyl acetate copolymer (EVA), polyhexamethylene terephthalate, polystyrenes, polyvinyl chlorides, polytetrafluoroethenes, polyesters (e.g., polylactic acid), polyethers, polyether sulfones, polyetherether ketones, polyacrylates, polymethacrylates, polyimides, acrylonitrile butadiene styrene (ABS), polyphenylene sulfides, vinyl polymers, polyarylene ethers, polyarylene sulfides, polysulfones, polyether ketones, polyamide-imides, polyetherimides, polyetheresters, copolymers comprising a polyether block and a polyamide block (PEBA or polyether block amide), functionalized or nonfunctionalized ethylene/vinyl monomer polymer, functionalized or nonfunctionalized ethylene/alkyl (meth)acrylates, functionalized or nonfunctionalized (meth)acrylic acid polymers, functionalized or nonfunctionalized ethylene/vinyl monomer/alkyl (meth)acrylate terpolymers, ethylene/vinyl monomer/carbonyl terpolymers, ethylene/alkyl (meth)acrylate/carbonyl terpolymers, methylmethacrylate-butadiene-styrene (MBS)-type core-shell polymers, polystyrene-block-polybutadiene-block-poly(methyl methacrylate) (SBM) block terpolymers, chlorinated or chlorosulphonated polyethylenes, polyvinylidene fluoride (PVDF), phenolic resins, poly(ethylene/vinyl acetate), polybutadienes, polyisoprenes, styrenic block copolymers, polyacrylonitriles, silicones, the like, and any combination thereof. Copolymers comprising one or more of the foregoing may also be used in the methods and systems of the present disclosure. In some cases, copolymers of PE with polar monomers, such as poly(ethylene-co-vinyl acetate), poly(ethylene-co-methyl acrylate), poly(ethylene-co-glycidyl methacrylate), and poly(ethylene-co-vinyl alcohol) may improve compatibility in polyethylene-poly(methylmethacrylate) (PE/PMMA) blends.

The thermoplastic polymers in the compositions and methods of the present disclosure may be elastomeric or non-elastomeric. Some of the foregoing examples of thermoplastic polymers may be elastomeric or non-elastomeric depending on the exact composition of the polymer.

Thermoplastic elastomers generally fall within one of six classes: styrenic block copolymers, thermoplastic vulcanizates (also referred to as elastomeric alloys), thermoplastic polyurethanes, thermoplastic copolyesters, and thermoplastic polyamides (typically block copolymers comprising polyamide). Examples of thermoplastic elastomers can be found in Handbook of Thermoplastic Elastomers, 2nd ed., B. M. Walker and C. P. Rader, eds., Van Nostrand Reinhold, New York, 1988. Examples of thermoplastic elastomers include, but are not limited to, elastomeric polyamides, polyurethanes, copolymers comprising a polyether block and a polyamide block (PEBA or polyether block amide), methyl methacrylate-butadiene-styrene (MBS)-type core-shell polymers, polystyrene-block-polybutadiene-block-poly(methyl methacrylate) (SBM) block terpolymers, polybutadienes, polyisoprenes, styrenic block copolymers, and polyacrylonitriles), silicones, and the like. Elastomeric styrenic block copolymers may include at least one block selected from the group of isoprene, isobutylene, butylene, ethylene/butylene, ethylene-propylene, and ethylene-ethylene/propylene. More specific elastomeric styrenic block copolymer examples include, but are not limited to, poly(styrene-ethylene/butylene), poly(styrene-ethylene/butylene-styrene), poly(styrene-ethylene/propylene), styrene-ethylene/propylene-styrene), poly(styrene-ethylene/propylene-styrene-ethylene-propylene), poly(styrene-butadiene-styrene), poly(styrene-butylene-butadiene-styrene), the like, and any combination thereof.

Examples of polyamides include, but are not limited to, polycaproamide (nylon 6, polyamide 6, or PA6), poly(hexamethylene succinamide) (nylon 4,6, polyamide 4,6, or PA4,6), polyhexamethylene adipamide (nylon 6,6, polyamide 6,6, or PA6,6), polypentamethylene adipamide (nylon 5,6, polyamide 5,6, or PA5,6), polyhexamethylene sebacamide (nylon 6,10, polyamide 6,10, or PA6,10), polyundecaamide (nylon 11, polyamide 11, or PA11), polydodecaamide (nylon 12, polyamide 12, or PA12), and polyhexamethylene terephthalamide (nylon 6T, polyamide 6T, or PA6T), nylon 10,10 (polyamide 10,10 or PA10,10), nylon 10,12 (polyamide 10,12 or PA10,12), nylon 10,14 (polyamide 10,14 or PA10,14), nylon 10,18 (polyamide 10,18 or PA10,18), nylon 6,18 (polyamide 6,18 or PA6,18), nylon 6,12 (polyamide 6,12 or PA6,12), nylon 6,14 (polyamide 6,14 or PA6,14), nylon 12,12 (polyamide 12,12 or PA12,12), the like, and any combination thereof. Copolyamides may also be used. Examples of copolyamides include, but are not limited to, PA 11/10,10, PA 6/11, PA 6,6/6, PA 11/12, PA 10,10/10,12, PA 10,10/10,14, PA 11/10,36, PA 11/6,36, PA 10,10/10,36, PA 6T/6,6, the like, and any combination thereof. A polyamide followed by a first number comma second number is a polyamide having the first number of backbone carbons between the nitrogens for the section having no pendent ═O and the second number of backbone carbons being between the two nitrogens for the section having the pendent ═O. By way of non-limiting example, nylon 6,10 is [NH—(CH₂)₆—NH—CO—(CH₂)₈—CO]ₙ. A polyamide followed by number(s) backslash number(s) are a copolymer of the polyamides indicated by the numbers before and after the backslash.

Examples of polyurethanes include, but are not limited to, polyether polyurethanes, polyester polyurethanes, mixed polyether and polyester polyurethanes, the like, and any combination thereof. Examples of thermoplastic polyurethanes include, but are not limited to, poly[4,4′-methylenebis(phenylisocyanate)-alt-1,4-butanediol/di(propylene glycol)/polycaprolactone], ELASTOLLAN® 1190A (a polyether polyurethane elastomer, available from BASF), ELASTOLLAN® 1190A10 (a polyether polyurethane elastomer, available from BASF), the like, and any combination thereof.

Polyolefins may be polymers of one or more monomers that may include, but are not limited to, substituted or unsubstituted C₂ to C₄₀ alpha olefins, preferably C₂ to C₂₀ alpha olefins, preferably C₂ to C₁₂ alpha olefins, preferably ethylene, propylene, butene, pentene, hexene, heptene, octene, nonene, decene, undecene, dodecane, and isomers thereof. For example, the polyolefin may comprise propylene and an optional comonomers comprising one or more ethylene or C₄ to C₄₀ olefins, preferably C₄ to C₂₀ olefins, or preferably C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and/or one or more functional groups. In another example, the polyolefin may comprise ethylene and an optional comonomers comprising one or more C₃ to Coo olefins, preferably C₄ to C₂₀ olefins, or preferably C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and/or one or more functional groups. Examples of specific polyolefins may include, but are not limited to, polyethylene (as a homopolymer or a copolymer having 35 wt % or less of a C₂ to C₄₀ alpha olefin comonomer), polypropylene (as a homopolymer or a copolymer having 35 wt % or less of a C₄ to C₄₀ alpha olefin comonomer), ethylene-propylene copolymers, ethylene-propylene-diene copolymers, polybutene, polyisobutylene, polymethylpentene, poly (4-methyl-1-pentene), the like, and any combination thereof.

The thermoplastic polymer may optionally comprise an additive. Typically, the additive may be present before forming polymer particles used to form the polymer body. The additive may be dispersed throughout the thermoplastic polymer and may be referred to herein as an “internal additive.” The internal additive may be blended with the thermoplastic polymer (e.g., as a blend or composite) before forming the polymer particles. The internal additives may be present primarily within the interior of the polymer particles, although some of the internal additives may reside at a surface location of the polymer particles as well.

When describing component amounts in various compositions described herein, weight percentages are expressed based on the polymer mass exclusive of the internal additive (if any). For example, a composition comprising 1 wt % of emulsion stabilizer, discussed further below, by weight of 100 g of thermoplastic polymer blend comprising 10 wt % internal additive and 90 wt % polymer is a composition comprising 0.9 g of emulsion stabilizer, 90 g of polymer, and 10 g of internal additive.

If present, an internal additive may be present in the polymer at about 0.1 wt % to about 60 wt %, or about 0.1 wt % to about 5 wt %, or about 1 wt % to about 10 wt %, or about 5 wt % to about 20 wt %, or about 10 wt % to about 30 wt %, or about 25 wt % to about 50 wt %, or about 40 wt % to about 60 wt % of the polymer. For example, a polymer body may comprise about 70 wt % to about 85 wt % of a thermoplastic polymer and about 15 wt % to about 30 wt % of an internal additive like glass fiber, carbon fiber, or other internal additives provided below. Other examples of suitable internal additives include, but are not limited to, fillers, strengtheners, pigments, pH regulators, the like, and combinations thereof. Examples of fillers include, but are not limited to, glass fibers, glass particles, mineral fibers, carbon fiber, oxide particles (e.g., titanium dioxide and zirconium dioxide), metal particles (e.g., aluminum powder), nanoparticles the like, and any combination thereof. Examples of pigments include, but are not limited to, organic pigments, inorganic pigments, carbon black, the like, and any combination thereof. For example, fillers used herein may include exfoliated graphite (EG), exfoliated graphite nanoplatelets (xGnP), carbon black, carbon nanofibers (CNF), carbon nanotubes (CNT), graphenes, graphene oxides, graphite oxides, graphene oxide nanosheets, fullerenes.

In some instances, internal additives also include two-dimensional conductive nanoparticles. When two-dimensional conductive nanoparticles are included as an internal additive of a polymer particle or a polymer body formed therefrom, at least a portion of the two-dimensional conductive nanoparticles may extend to the surface of the polymer particle or polymer body. The portion of the two-dimensional conductive nanoparticles extending to the surface of the polymer body may still promote catalyst metal deposition and electroless plating in a similar manner to that described elsewhere herein.

Example catalyst metals suitable for promoting electroless plating may include Group 10 and Group 11 metals including, but not limited to, copper, silver, palladium, platinum, the like, and any combination thereof. Example catalyst metal precursors for introducing the catalyst metal may include a metal complex or a salt of the catalyst metal, such as a metal fluoride, chloride, bromide, iodide, sulfate, or nitrate salt. Two or more catalyst metal precursors may be used to introduce catalyst metal in some instances. Examples of first reducing agents suitable to form catalyst metal may include, but are not limited to, sodium hypophosphite, borohydride salts, tin (II) salts, the like, and any combination thereof. Other suitable conditions for introducing catalyst metal upon a surface will be familiar to one having ordinary skill in the art.

The methods of the present disclosure may further comprise depositing the catalyst metal upon at least a portion of the outer surface of the polymer body. Deposition of catalyst metal upon the outer surface of the polymer body may be achieved by contacting the outer surface with a catalyst metal precursor and/or the first reducing agent in a solution (or dispersion) of the catalyst metal precursor and/or the first reducing agent in a solvent that does not affect the polymer, such as through swelling or degradation of a thermoplastic polymer. Such contacting may comprise soaking the polymer body or a portion thereof in the solution (or dispersion) with or without agitation and/or stirring, flowing the solution (or dispersion) over the polymer body or a portion thereof, the like, and any combination thereof. Similar exposure methods are applicable when disposing two-dimensional conductive nanoparticles upon an outer surface of the polymer particles or upon the outer surface of a polymer body. Likewise, such exposure methods may also be utilized when contacting the plating metal precursor, the second reducing agent, and the like under electroless plating conditions to form the plating metal of the metal coating.

Suitable two-dimensional conductive nanoparticles for use in the disclosure herein may include, but are not limited to, graphene, reduced graphene oxide, a two-dimensional transition metal compound, and any combination thereof. Illustrative examples of two-dimensional transition metal compounds include MXenes, which comprise a layered structure of transition metal carbides, nitrides, or carbonitrides. Suitable transition metals for forming the two-dimensional transition metal compounds may include, but are not limited to, Ti, Mo, V, and any combination thereof. Suitable MXenes may further comprise a surface terminating group, such as a hydrogen, an oxygen, a sulfur, a hydroxyl (OH), a halide (F, Cl, or Br), and any combination thereof.

Reduced graphene oxide (rGO) may be deposited directly onto the outer surface of a polymer body or polymer particles. Alternatively, graphene oxide (GO) may be deposited on the outer surface and then reduced to yield reduced graphene oxide (e.g., via chemical reduction using a reducing agent like ascorbic acid or other suitable reducing agent) on the outer surface. As will be appreciated, chemical reduction of graphene oxide may increase the electrical conductivity of this nanomaterial.

The two-dimensional conductive nanoparticles may be present at about 0.00001 wt % or higher relative to a mass of plating metal in the metal coating, such as about 0.00001 wt % to about 5 wt %, or about 0.0001 wt % to about 0.1 wt %, or about 0.00005 wt % to about 0.05 wt %, or about 0.0005 wt % to about 0.01 wt %, or about 0.001 wt % to about 0.5 wt %, or about 0.00001 wt % to about 0.001 wt %.

Areal coverage of the two-dimensional conductive nanoparticles upon the polymer body (before incorporation of the metal coating thereon) may range from about 5% to about 100%, or about 10% to about 80%, or about 20% to about 60%.

A mass ratio of the two-dimensional conductive nanoparticles to surface area upon the polymer body (before incorporation of the metal coating thereon) may range from about 0.01 μg/cm² to about 10 μg/cm², or about 0.1 μg/cm² to about 5 μg/cm².

A mass ratio of the two-dimensional conductive nanoparticles to the catalyst metal may range from about 1,000:1 to about 1:1,000, or about 500:1 to about 1:500, or about 1,000:1 to about 500:1 or about 500:1 to about 100:1, or about 100:1 to about 1:1, or about 1:1 to about 1:100, or about 1:100 to about 1:500, or about 1:500 to about 1:1,000, or about 1:1 to about 1:100, or about 1:1 to about 1:25, or about 1:10 to about 1:50, or about 1:25 to about 1:75, or about 1:50 to about 1:100.

A mass ratio of catalyst metal to surface area upon the polymer body (before incorporation of the metal coating thereon) may be about 0.001 μg/cm² or above, or about 0.01 μg/cm² or above, such as illustrative ranges of about 0.001 μg/cm² to about 10 μg/cm², or about 0.01 μg/cm² to about 5 μg/cm². In the foregoing, surface area refers to either the total area of the polymer body or the combined surface area of the polymer body and two-dimensional conductive nanoparticles located thereon.

The metal coating may comprise a portion deposited electrolessly and optionally a portion deposited electrolytically upon the portion that is deposited electrolessly. When both types of coating procedures are performed, the metal coating upon the outer surface of the polymer body may have a combined thickness up to about 50 microns, such as about 1 micron to about 50 microns. In illustrative embodiments, the metal coating may have a thickness ranging from about 500 nm to about 25 microns, or about 500 nm to about 10 microns, or about 500 nm to about 5 microns. The electroless portion of the coating may have a thickness ranging from about 0.005 μm to about 10 μm, or about 0.01 μm to about 5 μm, or about 0.1 μm to about 5 μm.

Suitable plating metals for deposition through electroless plating onto the outer surface of a polymer body may include, but are not limited to, copper, silver, gold, nickel, chromium, the like, any alloy thereof, and any combination thereof. Example plating metal precursors for introducing the plating metal may include a metal complex (including metal chelates) or a salt of the plating metal, such as a metal fluoride, chloride, bromide, iodide, sulfate, or nitrate salt. Two or more plating metal precursors may be used to introduce the metal coating in some instances. Examples of second reducing agents suitable to form the metal coating from the plating metal precursor may include, but are not limited to, sodium hypophosphite, borohydride salts, formaldehyde, the like, and any combination thereof. The second reducing agent may be the same as or different than the first reducing agent. Other parameters of an electroless plating process are provided below.

A mass ratio of the catalyst metal to the plating metal may be about 1:5 or greater, such as about 1:5 to about 1:10,000, or about 1:1 to about 1:1,000, or about 1:5 to about 1:100, or about 1:5 to about 1:25, or about 1:10 to about 1:50, or about 1:25 to about 1:75, or about 1:50 to about 1:100.

Suitable electroless plating conditions will be familiar to one having ordinary skill in the art and may be employed in the disclosure herein. Copper, for example, may be plated under electroless conditions using copper ethylenediaminetetraacetic acid complex (Cu-EDTA)/formaldehyde. In another particular example, copper-nickel alloys may be plated under electroless conditions using copper hypophosphite in the presence of nickel ions as a mediator. Nickel may be plated under electroless conditions using a nickel salt, such as nickel sulfate, for example, and a reducing agent such as hypophosphite or borohydride.

The metal coating of the polymer body may cover about 1% to about 100%, or about 25% to about 60%, or about 50% to about 80%, or about 75% to about 100% of the outer surface of the polymer body. That is, the metal coating may be at least partially continuous. The metal coating may be continuous or substantially continuous in some instances. The coverage of the metal coating on the outer surface of the polymer body may be determined using image analysis of SEM micrographs where elemental analysis images may be useful in ascertaining the locations of the coating (e.g., to detect the location of the metal).

The metal coating of the polymer body may comprise about 1 wt % to about 5 wt %, or about 5 wt % to about 50 wt %, or about 5 wt % to about 25 wt %, or about 15 wt % to about 30 wt %, or about 25 wt % to about 50 wt % of a combined mass of the thermoplastic polymer and the metal coating.

The polymer body, preferably formed through additive manufacturing, or a metallized polymer body formed therefrom, may have a void percentage of about 5% or less, such as 0% to about 5%, or about 0.5% to about 2%, or about 1% to about 3%, or about 2% to about 5% after polymer particle consolidation takes place. For example, consolidation of polymer particles may take place in a 3-D printing apparatus employing a laser, such that heating and consolidation take place by selective laser sintering. More specifically, particle consolidation methods may comprise depositing polymer particles in at least a portion of a powder bed, and consolidating at least a portion of the polymer particles in the powder bed to form the polymer body, wherein consolidation may take place using a laser, according to some embodiments. Polymer particles with or without a two-dimensional conductive nanoparticle layer may be consolidated in this manner.

The metallized polymer bodies described herein may exhibit electrical conductivity properties and/or electromagnetic interference (or shielding) properties, as well as other aesthetic and functional benefits.

Examples of articles that may feature metallized polymer bodies include, but are not limited to, particles, films, packaging, toys, household goods, automotive parts, aerospace/aircraft-related parts, containers (e.g., for food, beverages, cosmetics, personal care compositions, medicine, and the like), shoe soles, furniture parts, decorative home goods, plastic gears, screws, nuts, bolts, cable ties, jewelry, art, sculpture, medical items, prosthetics, orthopedic implants, production of artifacts that aid learning in education, 3D anatomy models to aid in surgeries, robotics, biomedical devices (orthotics), home appliances, dentistry, electronics, sporting goods, and the like.

### Melt Emulsification Methods and Resultant Polymer Particles

Highly spherical polymer particles that comprise one or more thermoplastic polymers may be produced by melt emulsification methods. For example, such methods may comprise: combining a thermoplastic polymer and, optionally, an emulsion stabilizer and/or other additives (e.g., a compatibilizer, a two-dimensional conductive nanoparticle, or the like) at a heating temperature at or above a melting point or softening temperature of the thermoplastic polymer and applying sufficient shear to disperse the thermoplastic polymer as liquefied droplets in the carrier fluid; cooling the liquefied droplets below the melting point or softening temperature to form polymer particles, which may be spherical or substantially spherical; and separating the polymer particles from the carrier fluid. Such polymer particles may be provided for formation of a polymer body and subsequent metal coating formation thereon according to the disclosure herein. Further, such polymer particles may be at least partially coated with two-dimensional conductive nanoparticles before being provided for formation of a consolidated body according to the disclosure herein.

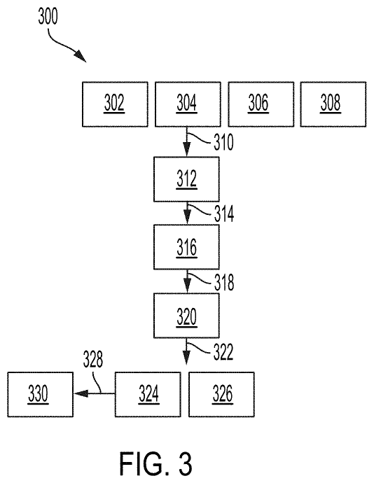

FIG. 3 is a flow chart of non-limiting example method 300 for melt emulsification production of highly spherical polymer particles. Thermoplastic polymer 302, carrier fluid 304, optionally emulsion stabilizer 306, and optionally other additives 308 (e.g., a compatibilizer, a two-dimensional conductive nanoparticle, and the like) are combined 310 to produce mixture 312. The foregoing components can be added individually or in a blend of components in any order and include mixing and/or heating during the process of combining 310. For example, thermoplastic polymer 302 and other additives 308 may be premixed before combining 310. In another example, emulsion stabilizer 306 may be added while combining 310 and after addition of thermoplastic polymer 302. In still another example, emulsion stabilizer 306 may first be dispersed in carrier fluid 304, optionally with heating the resulting dispersion, before adding thermoplastic polymer 302 and other additives 308, if included. In yet another example, thermoplastic polymer 302 may be heated to produce a polymer melt to which the other optional or other non-optional components may be added together or in any order.

During melt emulsification, the thermoplastic polymer may be present in the mixture (e.g., mixture 312 of FIG. 3) at about 5 wt % to about 60 wt %, or about 5 wt % to about 25 wt %, or about 10 wt % to about 30 wt %, or about 20 wt % to about 45 wt %, or about 25 wt % to about 50 wt %, or about 40 wt % to about 60 wt % of the mixture.

The thermoplastic polymer may be present in the polymer particles (e.g., polymer particles 324/330 of FIG. 3) at about 10 wt % to about 99 wt %, or about 10 wt % to about 80 wt %, or about 60 wt % to about 90 wt %, or about 80 wt % to about 95 wt %, or about 85 wt % to about 98 wt %, or about 90 wt % to about 99 wt % of the polymer particles.

Examples of suitable thermoplastic polymers that may undergo melt emulsification include, but are not limited to, the thermoplastic polymers described above that may be present in polymer particles or a polymer body.

The thermoplastic polymer may have a melting point or softening temperature of about 50° C. to about 450° C., or about 50° C. to about 125° C., or about 100° C. to about 175° C., or about 150° C. to about 280° C., or about 200° C. to about 350° C., or about 300° C. to about 450° C.

The thermoplastic polymer may have a glass transition temperature (ASTM E1356-08(2014) with 10° C./min ramping and cooling rates) of about −50° C. to about 400° C., or about −50° C. to about 0° C., or about −25° C. to about 50° C., or about 0° C. to about 150° C., or about 100° C. to about 250° C., or about 150° C. to about 300° C., or about 200° C. to about 400° C.

The thermoplastic polymer may optionally comprise an internal additive as described above with respect to polymer particles.

The carrier fluid may be chosen such that at the various processing temperatures (e.g., from room temperature to process temperature) the thermoplastic polymer and the carrier fluid are immiscible. An additional factor that may be considered is the differences in (e.g., a difference or a ratio of) viscosity at process temperature between the thermoplastic polymer and the carrier fluid. The differences in viscosity may affect droplet breakup and particle size distribution. Without being limited by theory, it is believed that when the viscosities of the thermoplastic polymer and the carrier fluid are too similar, the circularity of the product as a whole may be reduced where the particles are more ovular and more elongated structures are observed.

Suitable carrier fluids may have a viscosity at 25° C. of about 1,000 cSt to about 150,000 cSt, or about 1,000 cSt to about 60,000 cSt, or about 40,000 cSt to about 100,000 cSt, or about 75,000 cSt to about 150,000 cSt. For example, suitable carrier fluids may have a viscosity at 25° C. of about 10,000 cSt to about 60,000 cSt.

Examples of carrier fluids may include, but are not limited to, silicone oil, fluorinated silicone oils, perfluorinated silicone oils, polyethylene glycols, alkyl-terminal polyethylene glycols (e.g., C1-C4 terminal alkyl groups like tetraethylene glycol dimethyl ether (TDG)), paraffins, liquid petroleum jelly, vison oils, turtle oils, soya bean oils, perhydrosqualene, sweet almond oils, calophyllum oils, palm oils, parleam oils, grapeseed oils, sesame oils, maize oils, rapeseed oils, sunflower oils, cottonseed oils, apricot oils, castor oils, avocado oils, jojoba oils, olive oils, cereal germ oils, esters of lanolic acid, esters of oleic acid, esters of lauric acid, esters of stearic acid, fatty esters, higher fatty acids, fatty alcohols, polysiloxanes modified with fatty acids, polysiloxanes modified with fatty alcohols, polysiloxanes modified with polyoxy alkylenes, the like, and any combination thereof. Examples of silicone oils include, but are not limited to, polydimethylsiloxane (PDMS), methylphenylpolysiloxane, an alkyl modified polydimethylsiloxane, an alkyl modified methylphenylpolysiloxane, an amino modified polydimethylsiloxane, an amino modified methylphenylpolysiloxane, a fluorine modified polydimethylsiloxane, a fluorine modified methylphenylpolysiloxane, a polyether modified polydimethylsiloxane, a polyether modified methylphenylpolysiloxane, the like, and any combination thereof. When the carrier fluid comprises two or more of the foregoing, the carrier fluid may have one or more phases. For example, polysiloxanes modified with fatty acids and polysiloxanes modified with fatty alcohols (preferably with similar chain lengths for the fatty acids and fatty alcohols) may form a single-phase carrier fluid. In another example, a carrier fluid comprising a silicone oil and an alkyl-terminal polyethylene glycol may form a two-phase carrier fluid. In at least one embodiment, the carrier fluid is polydimethylsiloxane (PDMS).

The carrier fluid may be present in the mixture at about 40 wt % to about 95 wt %, or about 75 wt % to about 95 wt %, or about 70 wt % to about 90 wt %, or about 55 wt % to about 80 wt %, or about 50 wt % to about 75 wt %, or about 40 wt % to about 60 wt % of the mixture.

In some instances, the carrier fluid may have a density of about 0.6 g/cm³ to about 1.5 g/cm³, and the thermoplastic polymer may have a density of about 0.7 g/cm³ to about 1.7 g/cm³, wherein the thermoplastic polymer may have a density similar to, lower, or higher than the density of the carrier fluid.

Other additives like emulsion stabilizers, thermoplastic polymers, compatibilizers, the like, and any combination thereof may be included in the mixture and resultant polymer particles produced by melt emulsification.

The emulsion stabilizers used in the methods and compositions of the present disclosure may comprise nanoparticles (e.g., oxide nanoparticles), surfactants, the like, and any combination thereof.

Oxide nanoparticles may be metal oxide nanoparticles, non-metal oxide nanoparticles, or mixtures thereof. Examples of oxide nanoparticles include, but are not limited to, silica, titania, zirconia, alumina, iron oxide, copper oxide, tin oxide, boron oxide, cerium oxide, thallium oxide, tungsten oxide, the like, and any combination thereof. Mixed metal oxides and/or non-metal oxides, like aluminosilicates, borosilicates, and aluminoborosilicates, are also inclusive in the term metal oxide. The oxide nanoparticles may by hydrophilic or hydrophobic, which may be native to the particle or a result of surface treatment of the particle. For example, a silica nanoparticle having a hydrophobic surface treatment, like dimethyl silyl, trimethyl silyl, and the like, may be used in methods and compositions of the present disclosure. Additionally, silica with functional surface treatments like methacrylate functionalities may be used in methods and compositions of the present disclosure. Unfunctionalized oxide nanoparticles may also be suitable for use as well.

Commercially available examples of silica nanoparticles include, but are not limited to, AEROSIL® particles available from Evonik (e.g., AEROSIL® R812S (about 7 nm average diameter silica nanoparticles having a hydrophobically modified surface and a BET surface area of 260±30 m²/g), AEROSIL® RX50 (about 40 nm average diameter silica nanoparticles having a hydrophobically modified surface and a BET surface area of 35±10 m²/g), AEROSIL® 380 (silica nanoparticles having a hydrophilically modified surface and a BET surface area of 380±30 m²/g), the like, and any combination thereof.

Silica nanoparticles, particularly fumed silica nanoparticles with a hydrophobic functionalization thereon, may be especially suitable for use in the disclosure herein, since a variety of functionalized silicas are available, with the type of hydrophobic functionalization and the particle size being varied. Silazane and silane hydrophobic functionalizations are facile hydrophobic functionalizations that may be used in the present disclosure. As such, the plurality of oxide nanoparticles used in the disclosure herein may comprise or consist essentially of silica nanoparticles, particularly silica nanoparticles that are hydrophobically functionalized. Silica nanoparticles may be used in combination with another type of oxide nanoparticle or non-oxide nanoparticle wherein the other type of oxide or non-oxide nanoparticle may convey properties to the polymer particles, or an object formed therefrom, that are not attained when using silica nanoparticles alone.

The loading and particle size of silica nanoparticles or similar oxide nanoparticles upon polymer particles may vary over a wide range in the disclosure herein. The loading of the silica nanoparticles or similar oxide nanoparticles may be determined by the nanoparticle concentration in a carrier fluid used to promote formation of the polymer particles, as described further below. In non-limiting examples, the concentration of nanoparticles in the carrier fluid may range from about 0.01 wt % to about 10 wt %, or about 0.05 wt % to about 10 wt %, or about 0.05 wt % to about 5 wt %, or about 0.1 wt % to about 2 wt %, or about 0.25 wt % to about 1.5 wt %, or about 0.2 wt % to about 1.0 wt %, or about 0.25 wt % to about 1 wt %, or about 0.25 wt % to about 0.5 wt % with respect to the weight of the thermoplastic polymer. The particle size of the nanoparticles may range from about 1 nm to about 100 nm, although particles sizes up to about 500 nm may also be acceptable. In non-limiting examples, the particle size of the nanoparticles may range from about 5 nm to about 75 nm, or about 5 nm to about 50 nm, or about 5 nm to about 10 nm, or about 10 nm to about 20 nm, or about 20 nm to about 30 nm, or about 30 nm to about 40 nm, or about 40 nm to about 50 nm, or about 50 nm to about 60 nm. The nanoparticles, particularly silica nanoparticles and similar oxide nanoparticles, may have a BET surface area of about 10 m²/g to about 500 m²/g, or about 10 m²/g to about 150 m²/g, or about 25 m²/g to about 100 m²/g, or about 100 m²/g to about 250 m²/g, or about 250 m²/g to about 500 m²/g.

Even when silica nanoparticles are utilized to form polymer particles, the silica nanoparticles may be at least partially removed following melt-emulsification. Suitable techniques for silica removal may include treatment with an aqueous base, such as aqueous sodium hydroxide. As such, in some embodiments, the polymer particles may be free or substantially free of silica, and polymer bodies formed therefrom may similarly be substantially free of silica.

Surfactants may be anionic, cationic, nonionic, or zwitterionic. Examples of surfactants include, but are not limited to, sodium dodecyl sulfate, sorbitan oleates, poly[dimethylsiloxane-co-[3-(2-(2-hydroxyethoxy)ethoxy)propylmethylsiloxane]], docusate sodium (sodium 1,4-bis(2-ethylhexoxy)-1,4-dioxobutane-2-sulfonate), the like, and any combination thereof. Commercially available examples of surfactants include, but are not limited to, CALFAX® DB-45 (sodium dodecyl diphenyl oxide disulfonate, available from Pilot Chemicals), SPAN® 80 (sorbitan maleate non-ionic surfactant), MERPOL® surfactants (available from Stepan Company), TERGITOL™ TMN-6 (a water-soluble, nonionic surfactant, available from Dow), TRITON™ X-100 (octyl phenol ethoxylate, available from SigmaAldrich), IGEPAL® CA-520 (polyoxyethylene (5) isooctylphenyl ether, available from SigmaAldrich), BRIJ® S10 (polyethylene glycol octadecyl ether, available from SigmaAldrich), the like, and any combination thereof.

The emulsion stabilizer may be included in the mixture (e.g., mixture 312 of FIG. 3) in an amount of about 0.01 wt % to about 10 wt %, or about 0.01 wt % to about 1 wt %, or about 0.1 wt % to about 3 wt %, or about 1 wt % to about 5 wt %, or about 5 wt % to about 10 wt % based on a total weight of thermoplastic polymer in the mixture. The emulsion stabilizer may be present in similar concentrations in the polymer particles.

Surfactants may be included in the mixture (e.g., mixture 312 of FIG. 3) in an amount of about 0.01 wt % to about 10 wt %, or about 0.01 wt % to about 1 wt %, or about 0.5 wt % to about 2 wt %, or about 1 wt % to about 3 wt %, or about 2 wt % to about 5 wt %, or about 5 wt % to about 10 wt % based on a total weight of thermoplastic polymer in the mixture. Alternatively, the mixture may comprise no (or be absent of) surfactant.

A weight ratio of nanoparticles to surfactant in the emulsion stabilizer in the mixture (e.g., mixture 312 of FIG. 3) may be about 1:10 to about 10:1, or about 1:10 to about 1:1, or about 1:5 to about 5:1, or about 1:1 to about 10:1.

Referring still to FIG. 3, at least a portion of combining 310 may occur in a mixing apparatus used for the processing and/or in another suitable vessel. By way of non-limiting example, thermoplastic polymer 302 may be heated to a temperature greater than the melting point or softening temperature in the mixing apparatus used for the processing, and the emulsion stabilizer may be dispersed in the carrier fluid in another vessel. Then, the dispersion may be added to the melt in the mixing apparatus used for the processing.

Mixture 312 is then processed 314 by applying sufficiently high shear to mixture 312 at a temperature greater than the melting point or softening temperature of thermoplastic polymer 302 to form melt emulsion 316. The shear rate should be sufficient enough to disperse the polymer melt (e.g., comprising thermoplastic polymer 302) in carrier fluid 304 as liquefied droplets (i.e., as melt emulsion 316). Without being limited by theory, it is believed that, all other factors being the same, increasing shear should decrease the size of the liquefied droplets of the polymer melt in carrier fluid 304. However, at some point there may be diminishing returns on increasing shear and decreasing droplet size or there may be disruptions to the droplet contents that decrease the quality of particles produced therefrom.

Mixing apparatuses used for processing 314 to produce melt emulsion 316 may be capable of maintaining melt emulsion 316 at a temperature greater than the melting point or softening temperature of the thermoplastic polymer(s) in mixture 312 (e.g., the one or more polymers of the thermoplastic polymer 302) described herein and applying a shear rate sufficient to disperse the polymer melt in the carrier fluid as droplets.

Examples of mixing apparatuses used for the processing to produce the melt emulsion may include, but are not limited to, extruders (e.g., continuous extruders, batch extruders, and the like), stirred reactors, blenders, reactors with inline homogenizer systems, the like, and apparatuses derived therefrom.

The temperature of the processing and forming the melt emulsion is a temperature greater than the melting point or softening temperature of the thermoplastic polymer(s) in mixture 312 described herein and less than the decomposition temperature of any components in the mixture specified above. For example, the temperature of processing 314 and forming melt emulsion 316 may be about 1° C. to about 50° C., or about 1° C. to about 25° C., or about 5° C. to about 30° C., or about 20° C. to about 50° C. greater than the melting point or softening temperature of the thermoplastic polymer(s) in the mixture described herein, provided the temperature of processing and forming the melt emulsion is less than the decomposition temperature of any components in the mixture.

The shear rate of processing 314 and forming melt emulsion 316 is sufficiently high to disperse the polymer melt in the carrier fluid as liquefied droplets. The liquefied droplets may have a diameter of about 1000 μm or less, or about 1 μm to about 1000 μm, or about 1 μm to about 50 μm, or about 10 μm to about 100 μm, or about 10 μm to about 250 μm, or about 50 μm to about 500 μm, or about 250 μm to about 750 μm, or about 500 μm to about 1000 μm. Polymer particles may be formed in the same range of particle diameters.

The time for maintaining the temperature and shear rate for processing 314 and forming melt emulsion 316 may be about 10 seconds to about 18 hours or longer, or about 10 seconds to about 30 minutes, or about 5 minutes to about 1 hour, or about 15 minutes to about 2 hours, or about 1 hour to about 6 hours, or about 3 hours to about 18 hours. Without being limited by theory, it is believed that once a steady state of droplet sizes is reached, processing can be stopped. That time may depend on, among other things, the temperature, shear rate, and the components in mixture 312.

The melt emulsion 316 inside and/or outside the mixing vessel is then cooled 318 to solidify the liquefied droplets into polymer particles 324. Cooling 318 can be slow (e.g., allowing the melt emulsion to cool under ambient conditions, optionally with further temperature regulation to slow the cooling rate) to fast (e.g., quenching). For example, the rate of cooling may range from about 10° C./hour to about 100° C./second to almost instantaneous with quenching (for example in dry ice), or about 10° C./hour to about 60° C./hour, or about 0.5° C./minute to about 20° C./minute, or about 1° C./minute to about 5° C./minute, or about 10° C./minute to about 60° C./minute, or about 0.5° C./second to about 10° C./second, or about 10° C./second to about 100° C./second.

During cooling 318, little to no shear may be applied to the melt emulsion. In some instances, the shear applied during heating may be applied during cooling 318.

Cooled mixture 320 resulting from cooling 318 melt emulsion 316 may comprise solidified polymer particles and other components (e.g., the carrier fluid, excess emulsion stabilizer, and the like). The solidified polymer particles 324 may be dispersed in the carrier fluid and/or settled in the carrier fluid. Cooled mixture 320 can then be treated 322 to isolate thermoplastic polymer particles 324 from other components 326 (e.g., carrier fluid 304, excess emulsion stabilizer 306, and the like) and wash or otherwise purify polymer particles 324.

When used, emulsion stabilizers may be at the interface between the polymer melt and the carrier fluid in the melt emulsion. As a result, when the mixture is cooled, the emulsion stabilizers remain at, or in the vicinity of, said interface. Therefore, the resulting polymer particles may include emulsion stabilizers (a) dispersed on an outer surface of the polymer particles and/or (b) embedded in an outer portion (e.g., outer 1 vol %) of the polymer particles. That is, emulsion stabilizers, when included, may be deposited (or located) on the surface of the polymer particles. In some instances, which may be dependent upon non-limiting factors such as the temperature (including cooling rate), the type of thermoplastic polymer, and the types and sizes of emulsion stabilizers, the emulsion stabilizers may become at least partially embedded within the outer surface of the polymer particles. Even without embedment taking place, at least a portion of the emulsion stabilizers may remain robustly associated with the polymer particles to facilitate their further use. In contrast, dry blending already formed polymer particles (e.g., formed by cryogenic grinding or precipitation processes) with a flow aid like silica nanoparticles does not result in a robust, uniform coating of the flow aid upon the polymer particles.

At least a portion of a surfactant, if used during melt emulsification, may also be associated with the outer surface of the polymer particles as well.

Further, where voids form inside the liquefied droplets, emulsion stabilizers may be present at (and/or embedded in) the interface between the interior of the void and the thermoplastic polymer. The voids generally do not contain polymer. Rather, the voids may contain, for example, carrier fluid, air, or be void (empty). The polymer particles described herein may comprise carrier fluid at about 5 wt % or less, or about 0.001 wt % to about 5 wt %, or about 0.001 wt % to about 0.1 wt %, or about 0.01 wt % to about 0.5 wt %, or about 0.1 wt % to about 2 wt %, or about 1 wt % to about 5 wt % of the polymer particles.

The polymer particles 324 may comprise thermoplastic polymer 302, at least a portion of the emulsion stabilizer 306 (when included, and which may be at and/or embedded in the outer surface of the polymer particles 324), and the other additives 308 (e.g., a compatibilizer, two-dimensional conductive nanoparticles, etc.) (when included). At least a portion of emulsion stabilizer 306 may be removed prior to metallization and/or deposition of two-dimensional conductive nanoparticle according to the disclosure herein.

The polymer particles 324 may optionally be further purified or otherwise treated 328 to yield purified polymer particles 330. Suitable treatments include, but are not limited to, washing, filtering, centrifuging, decanting, the like, and any combination thereof.

Advantageously, carrier fluids and washing solvents of the systems and methods described herein can be recycled and reused, if desired.

The polymer particles may be washed with water to remove surfactant, if present, while retaining substantially all of the emulsion stabilizer associated with the outer surface of the polymer particles. Alternatively, washing may be used to remove some or all of the emulsion stabilizer from the surface of the polymer particles. For example, silica nanoparticle emulsion stabilizers may be at least partially removed by washing the polymer particles with an aqueous base. For surfactants, pyrolysis may be used in addition to or an alternative to washing, depending on the thermoplastic polymer.

Solvents used for washing the polymer particles may be chosen to be (a) miscible with the carrier fluid and (b) nonreactive (e.g., non-swelling and non-dissolving) with the polymer(s) of the polymer particles. Examples of suitable solvents include, but are not limited to, hydrocarbon solvents (e.g., pentane, hexane, heptane, octane, cyclohexane, cyclopentane, decane, dodecane, tridecane, and tetradecane), aromatic hydrocarbon solvents (e.g., benzene, toluene, xylene, 2-methyl naphthalene, and cresol), ether solvents (e.g., diethyl ether, tetrahydrofuran, diisopropyl ether, and dioxane), ketone solvents (e.g., acetone and methyl ethyl ketone), alcohol solvents (e.g., methanol, ethanol, isopropanol, and n-propanol), ester solvents (e.g., ethyl acetate, methyl acetate, butyl acetate, butyl propionate, and butyl butyrate), halogenated solvents (e.g., chloroform, bromoform, 1,2-dichloromethane, 1,2-dichloroethane, carbon tetrachloride, chlorobenzene, and hexafluoroisopropanol), water, the like, and any combination thereof.

Solvent may be removed from the polymer particles by drying using an appropriate method such as air-drying, heat-drying, reduced pressure drying, freeze drying, or a hybrid thereof. Heating may be performed at a temperature lower than the glass transition temperature of the polymer (e.g., about 50° C. to about 150° C.).

When using polymer particles produced by melt emulsification for making additively manufactured polymer bodies and, ultimately, metallized polymer bodies, the emulsion stabilizers may remain upon the outer surface of the polymer particles or at least a portion of the emulsion stabilizers may be removed, including such that no or a minimal amount of emulsion stabilizers remain present on the polymer particles. Without being limited by theory, it is believed that emulsion stabilizers that are electrically insulating (e.g., silica, titania, and the like) may reduce the amount of metal that may be added to the metal coating via electroless plating. Further, surfactants may interfere with the chemistry of the electroless plating and also mitigate the deposition of metal as well. Therefore, decreasing the amount of emulsion stabilizers and other components on the surface of the polymer particles may be desirable prior to formation of a polymer body.

Emulsion stabilizers (e.g., surfactants and/or nanoparticles) may be disposed substantially uniformly upon the outer surface of the polymer particles. The term “substantially uniform” refers to an even thickness in surface locations covered by the emulsion stabilizer, particularly the entirety of the outer surface. The emulsion stabilizers may cover at least about 5%, or about 5% to about 100%, or about 5% to about 25%, or about 20% to about 50%, or about 40% to about 70%, or about 50% to about 80%, or about 60% to about 90%, or about 70% to about 100% of the surface area of the polymer particles. When purified to at least partially remove surfactant or another emulsion stabilizer, the emulsion stabilizers may be present on an outer surface of the polymer particles at less than 25%, or 0% to about 25%, or about 0.1% to about 5%, or about 0.1% to about 1%, or about 1% to about 5%, or about 1% to about 10%, or about 5% to about 15%, or about 10% to about 25% of the surface area of the polymer particles. The coverage of the emulsion stabilizers on an outer surface of the polymer particles may be determined using image analysis of the scanning electron microscope images (SEM micrographs).

The polymer particles, after separation from the other components, may optionally be further purified or otherwise treated. For example, to narrow the particle size distribution (or to reduce the diameter span), the polymer particles can be passed through a sieve having a pore size of about 10 μm to about 250 μm, or about 10 μm to about 100 μm, or about 50 μm to about 200 μm, or about 150 μm to about 250 μm.

Further, the polymer particles may be blended with additives to achieve a desired final product. For clarity, because such additives are blended with the polymer particles described herein after the particles are solidified, such additives are referred to herein as “external additives.” Examples of external additives include flow aids, other polymer particles, fillers, the like, and any combination thereof.

A weight ratio of nanoparticle emulsion stabilizer to surfactant in the emulsion stabilizer in the polymer particles may be about 1:10 to about 10:1, or about 1:10 to about 1:1, or about 1:5 to about 5:1, or about 1:1 to about 10:1.

Surfactants may be included in the polymer particles in an amount of about 0.01 wt % to about 10 wt %, or about 0.01 wt % to about 1 wt %, or about 0.5 wt % to about 2 wt %, or about 1 wt % to about 3 wt %, or about 2 wt % to about 5 wt %, or about 5 wt % to about 10 wt % based on a total weight of thermoplastic polymer in the polymer particles. Alternatively, the mixture may comprise no (or be absent of) surfactant.

The polymer particles may have a BET surface area of about 10 m²/g to about 500 m²/g, or about 10 m²/g to about 150 m²/g, or about 25 m²/g to about 100 m²/g, or about 100 m²/g to about 250 m²/g, or about 250 m²/g to about 500 m²/g.

The polymer particles may have a D₁₀ of about 0.1 μm to about 125 μm, or about 0.1 μm to about 5 μm, about 1 μm to about 10 μm, about 5 μm to about 30 μm, or about 1 μm to about 25 μm, or about 25 μm to about 75 μm, or about 50 μm to about 85 μm, or about 75 μm to about 125 μm, a D₅₀ of about 0.5 μm to about 200 μm, or about 0.5 μm to about 10 μm, or about 5 μm to about 50 μm, or about 30 μm to about 100 μm, or about 30 μm to about 70 μm, or about 25 μm to about 50 μm, or about 50 μm to about 100 μm, or about 75 μm to about 150 μm, or about 100 μm to about 200 μm, and a D₉₀ of about 3 μm to about 300 μm, or about 3 μm to about 15 μm, or about 10 μm to about 50 μm, or about 25 μm to about 75 μm, or about 70 μm to about 200 μm, or about 60 μm to about 150 μm, or about 150 μm to about 300 μm, wherein D₁₀<D₅₀<D₉₀. The polymer particles may also have a diameter span of about 0.2 to about 10 (or about 0.2 to about 0.5, or about 0.4 to about 0.8, or about 0.5 to about 1, or about 1 to about 3, or about 2 to about 5, or about 5 to about 10). Without limitation, diameter span values of 1.0 or greater are considered broad, and diameter spans values of 0.75 or less are considered narrow. Preferably, the polymer particles have a diameter span of about 0.2 to about 1.

In a first non-limiting example, the polymer particles may have a D₁₀ of about 0.1 μm to about 10 μm, a D₅₀ of about 0.5 μm to about 25 μm, and a D₉₀ of about 3 μm to about 50 μm, wherein D₁₀<D₅₀<D₉₀. The polymer particles may have a diameter span of about 0.2 to about 2.

In a second non-limiting example, the polymer particles may have a D₁₀ of about 5 μm to about 30 μm, a D₅₀ of about 30 μm to about 70 μm, and a D₉₀ of about 70 μm to about 120 μm, wherein D₁₀<D₅₀<D₉₀. The polymer particles may have a diameter span of about 1.0 to about 2.5.

In a third non-limiting example, the polymer particles may have a D₁₀ of about 25 μm to about 60 μm, a D₅₀ of about 60 μm to about 110 μm, and a D₉₀ of about 110 μm to about 175 μm, wherein D₁₀<D₅₀<D₉₀. The polymer particles may have a diameter span of about 0.6 to about 1.5.

In a fourth non-limiting example, the polymer particles may have a D₁₀ of about 75 μm to about 125 μm, a D₅₀ of about 100 μm to about 200 μm, and a D₉₀ of about 125 μm to about 300 μm, wherein D₁₀<D₅₀<D₉₀. Said polymer particles may have a diameter span of about 0.2 to about 1.2.

In a fifth non-limiting example, the polymer particles may have a D₁₀ of about 1 μm to about 50 μm, or about 5 μm to about 30 μm, or about 1 μm to about 25 μm, or about 25 μm to about 50 μm, a D₅₀ of about 25 μm to about 100 μm, or about 30 μm to about 100 μm, or about 30 μm to about 70 μm, or about 25 μm to about 50 μm, or about 50 μm to about 100 μm, and a D₉₀ of about 60 μm to about 300 μm, or about 70 μm to about 200 μm, or about 60 μm to about 150 μm, or about 150 μm to about 300 μm, wherein D₁₀<D₅₀<D₉₀. The polymer particles may also have a diameter span of about 0.4 to about 3, or about 0.6 to about 2, or about 0.4 to about 1.5, or about 1 to about 3.

The polymer particles may have a circularity of about 0.9 or greater, or about 0.90 to about 1.0, or about 0.93 to about 0.99, or about 0.95 to about 0.99, or about 0.97 to about 0.99, or about 0.98 to 1.0.

The polymer particles may have an angle of repose of about 25° to about 45°, or about 25° to about 35°, or about 30° to about 40°, or about 35° to about 45°.

The polymer particles may have a Hausner ratio of about 1.0 to about 1.5, or about 1.0 to about 1.2, or about 1.1 to about 1.3, or about 1.2 to about 1.35, or about 1.3 to about 1.5.

The polymer particles may have a bulk density of about 0.3 g/cm³ to about 0.8 g/cm³, or about 0.3 g/cm³ to about 0.6 g/cm³, or about 0.4 g/cm³ to about 0.7 g/cm³, or about 0.5 g/cm³ to about 0.6 g/cm³, or about 0.5 g/cm³ to about 0.8 g/cm³.

The polymer particles may have an aerated density of about 0.5 g/cm³ to about 0.8 g/cm³, or about 0.5 g/cm³ to about 0.7 g/cm³, or about 0.55 g/cm³ to about 0.80 g/cm³.

The polymer particles may have a tapped density of about 0.6 g/cm³ to about 0.9 g/cm³, or about 0.60 g/cm³ to about 0.75 g/cm³, or about 0.65 g/cm³ to about 0.80 g/cm³, or about 0.70 g/cm³ to about 0.90 g/cm³.

Depending on the temperature and shear rate of processing and the composition and relative concentrations of the components (e.g., thermoplastic polymer, the carrier fluid, excess emulsion stabilizer, and the like) different shapes of the polymer particles may be produced. Typically, the polymer particles may comprise substantially spherical particles having a circularity of about 0.97 or greater. However, other structures including disc and elongated structures may be observed in the polymer particles. Therefore, the polymer particles may comprise one or more of: (a) substantially spherical particles having a circularity of 0.97 or greater, (b) disc structures having an aspect ratio of about 2 to about 10, and (c) elongated structures having an aspect ratio of 10 or greater. Each of the (a), (b), and (c) structures have emulsion stabilizers dispersed on an outer surface of the (a), (b), and (c) structures and/or embedded in an outer portion of the (a), (b), and (c) structures. At least some of the (a), (b), and (c) structures may be agglomerated. For example, the (c) elongated structures may be laying on the surface of the (a) substantially spherical particles.

The polymer particles may have a sintering window that is within 10° C., preferably within 5° C., of the sintering window of the thermoplastic polymer or blend thereof used in the mixture.

Compatibilizers may optionally be used to improve the blending efficiency and efficacy when two or more thermoplastic polymers are used. Examples of polymer compatibilizers include, but not limited to, PROPOLDER™ MPP2020 20 (polypropylene, available from Polygroup Inc.), PROPOLDER™ MPP2040 40 (polypropylene, available from Polygroup Inc.), NOVACOM™ HFS2100 (maleic anhydride functionalized high density polyethylene polymer, available from Polygroup Inc.), KEN-REACT™ CAPS™ L™ 12/L (organometallic coupling agent, available from Kenrich Petrochemicals), KEN-REACT™ CAPOW™ L™ 12/H (organometallic coupling agent, available from Kenrich Petrochemicals), KEN-REACT™ LICA™ 12 (organometallic coupling agent, available from Kenrich Petrochemicals), KEN-REACT™ CAPS™ KPR™ 12/LV (organometallic coupling agent, available from Kenrich Petrochemicals), KEN-REACT™ CAPOW™ KPR™ 12/H (organometallic coupling agent, available from Kenrich Petrochemicals), KEN-REACT™ titanates & zirconates (organometallic coupling agent, available from Kenrich Petrochemicals), VISTAMAXX™ (ethylene-propylene copolymers, available from ExxonMobil), SANTOPRENE™ (thermoplastic vulcanizate of ethylene-propylene-diene rubber and polypropylene, available from ExxonMobil), VISTALON™ (ethylene-propylene-diene rubber, available from ExxonMobil), EXACT™ (plastomers, available from ExxonMobil) EXXELOR™ (polymer resin, available from ExxonMobil), FUSABOND™ M603 (random ethylene copolymer, available from Dow), FUSABOND™ E226 (anhydride modified polyethylene, available from Dow), BYNEL™ 41E710 (coextrudable adhesive resin, available from Dow), SURLYN™ 1650 (ionomer resin, available from Dow), FUSABOND™ P353 (a chemically modified polypropylene copolymer, available from Dow), ELVALOY™ PTW (ethylene terpolymer, available from Dow), ELVALOY™ 3427AC (a copolymer of ethylene and butyl acrylate, available from Dow), LOTADER™ AX8840 (ethylene acrylate-based terpolymer, available from Arkema), LOTADER™ 3210 (ethylene acrylate-based terpolymer, available from Arkema), LOTADER™ 3410 (ethylene acrylate-based terpolymer, available from Arkema), LOTADER™ 3430 (ethylene acrylate-based terpolymer, available from Arkema), LOTADER™ 4700 (ethylene acrylate-based terpolymer, available from Arkema), LOTADER™ AX8900 (ethylene acrylate-based terpolymer, available from Arkema), LOTADER™ 4720 (ethylene acrylate-based terpolymer, available from Arkema), BAXXODUR™ EC 301 (amine for epoxy, available from BASF), BAXXODUR™ EC 311 (amine for epoxy, available from BASF), BAXXODUR™ EC 303 (amine for epoxy, available from BASF), BAXXODUR™ EC 280 (amine for epoxy, available from BASF), BAXXODUR™ EC 201 (amine for epoxy, available from BASF), BAXXODUR™ EC 130 (amine for epoxy, available from BASF), BAXXODUR™ EC 110 (amine for epoxy, available from BASF), styrenics, polypropylene, polyamides, polycarbonate, EASTMAN™ G-3003 (a maleic anhydride grafted polypropylene, available from Eastman), RETAIN™ (polymer modifier available from Dow), AMPLIFY TY™ (maleic anhydride grafted polymer, available from Dow), INTUNE™ (olefin block copolymer, available from Dow), and the like and any combination thereof.

Embodiments disclosed herein include:

A. Articles having a metal coating. The articles comprise: a polymer body, optionally comprising a thermoplastic polymer; and a metal coating on at least a portion of an outer surface of the polymer body, the metal coating comprising a plating metal and overlaying a plurality of two-dimensional conductive nanoparticles and a catalyst metal.

B. Methods for forming a metal coating on an article. The methods comprise: providing a polymer body, optionally comprising a thermoplastic polymer, comprising a plurality of two-dimensional conductive nanoparticles and a catalyst metal upon an outer surface of the polymer body; and performing electroless plating upon the outer surface of the polymer body using a plating metal precursor to form a metal coating upon the outer surface of the polymer body, the metal coating comprising a plating metal and overlaying the plurality of two-dimensional conductive nanoparticles and the catalyst metal.

Embodiments A and B may have one or more of the following additional elements in any combination:

Element 1: wherein the plurality of two-dimensional conductive nanoparticles comprise a nanoparticle selected from the group consisting of graphene, reduced graphene oxide, a two-dimensional transition metal carbide, and any combination thereof.

Element 2: wherein the plurality of two-dimensional conductive nanoparticle comprises a MXene having a layered structure selected from the group consisting of a transition metal carbide, a transition metal nitride, a transition metal carbonitride, and any combination thereof.

Element 3: wherein the article further comprises an adhesion promoter interposed between the outer surface of the polymer body and the two-dimensional conductive nanoparticles, optionally wherein the adhesion promoter is selected from the group consisting of a dopamine or a silane coupling agent.

Element 3A: wherein an adhesion promoter is interposed between the outer surface of the polymer body and the two-dimensional conductive nanoparticles.

Element 4: wherein the metal coating has a thickness of about 1 micron to about 50 microns.

Element 5: wherein the plurality of two-dimensional conductive nanoparticles are present at about 0.00001 wt % to about 0.1 wt % relative to an amount of plating metal in the metal coating, and/or an areal coverage of the plurality of two-dimensional conductive nanoparticles upon the polymer body ranges from about 5% to about 100%, and/or a mass ratio of the plurality of two-dimensional conductive nanoparticles to surface area upon the polymer body ranges from about 0.01 μg/cm² to about 10 μg/cm², and/or a mass ratio of the plurality of two-dimensional conductive nanoparticles to the catalyst metal ranges from about 1,000:1 to about 1:1,000, and/or a mass ratio of catalyst metal to surface area upon the polymer body ranges from about 0.01 μg/cm² to about 10 μg/cm², and/or the metal coating comprises about 5 wt % to about 50 wt % of a combined mass of the polymer and the metal coating, and/or a mass ratio of the catalyst metal to the plating metal ranges from about 1:5 to about 1:100.

Element 6: wherein the catalyst metal comprises at least one of copper, silver, platinum, or palladium.

Element 7: wherein the plating metal comprises at least one of copper, silver, gold, chromium, nickel, or any alloy thereof.

Element 8: wherein at least a portion of the plurality of two-dimensional conductive nanoparticles is localized at an interface of the metal coating and the outer surface of the polymer body.

Element 9: wherein the polymer body is an additively manufactured polymer body produced by consolidation of polymer particles comprising a thermoplastic polymer.

Element 10: wherein the polymer particles comprise a two-dimensional conductive nanoparticle that is the same as or different than the plurality of two-dimensional conductive nanoparticles overlaid by the metal coating.

Element 11: wherein the polymer particles are substantially free of silica.

Element 12: wherein the method further comprises depositing the catalyst metal upon at least a portion of the outer surface of the polymer body, and wherein depositing the catalyst metal comprises contacting the polymer body with a catalyst metal precursor and a first reducing agent, and performing electroless plating comprises reducing the plating metal precursor with a second reducing agent, the second reducing agent being the same as or different than the first reducing agent.

Element 13: wherein the method further comprises: providing polymer particles comprising a thermoplastic polymer; depositing the polymer particles; and consolidating at least a portion of the polymer particles to form the polymer body, optionally wherein consolidating takes place using a laser. Optionally, depositing and consolidating takes place in a powder bed.

Element 14: wherein providing the polymer particles comprises: combining the thermoplastic polymer and optionally an emulsion stabilizer in a carrier fluid at a heating temperature at or above a melting point or softening temperature of the thermoplastic polymer, and applying sufficient shear to disperse the thermoplastic polymer as liquefied droplets in the carrier fluid; cooling the liquefied droplets below the melting point or softening temperature to form polymer particles; separating the polymer particles from the carrier fluid; and optionally, removing the emulsion stabilizer from the polymer particles.

Element 15: wherein the method further comprises: depositing the plurality of two-dimensional conductive nanoparticles upon an outer surface of a plurality of polymer particles lacking a surface coating.

Element 16: wherein providing the polymer body comprises depositing the plurality of two-dimensional conductive nanoparticles upon the outer surface of a polymer body lacking a surface coating.

Element 17: wherein the plurality of two-dimensional conductive nanoparticles is deposited before depositing the catalyst metal on the outer surface.

By way of non-limiting example, illustrative combinations applicable to A and B may include, but are not limited to, 1 or 2, and 3 or 3A; 1 or 2, and 4; 1 or 2, and 5; 1 or 2, 4 and 5; 1 or 2, and 6; 1 or 2, and 7; 1 or 2, and 8; 1 or 2, and 9; 1 or 2, and 10; 1 or 2, and 11; 3 or 3A, and 4; 3 or 3A, and 5; 3 or 3A, 4 and 5; 3 or 3A, and 6; 3 or 3A, and 7; 3 or 3A, and 8; 3 or 3A, and 9; 3 or 3A, and 10; 3 or 3A, and 11; 4 and 5; 4 and 6; 4 and 7; 4 and 8; 4 and 9; 4 and 10; 4 and 11; 5 and 6; 5 and 7; 5 and 8; 5 and 9; 5 and 10; 5 and 11; 6 and 7; 6 and 8; 6 and 9; 6 and 10; 6 and 11; 7 and 8; 7 and 9; 7 and 10; 7 and 11; 8 and 9; 8 and 10; 8 and 11; 9 and 10; 9 and 11; and 10 and 11. Additional illustrative combinations applicable to B include any of the foregoing in further combination with 12, 13, 14, 15, 16 or 16; any of 1, 2, 3, 3A, 4, 5, 6, 7, 8, 9, 10 or 11 in further combination with 12, 13, 14, 15, 16 or 17; 12 and 13; 12 and 14; 12-14; 12 and 15; 12-15; 12 and 16; 12-16; 12 and 17; 12-17; 13 and 14; 13 and 15; 13-15; 13 and 16; 13-16; 13 and 17; 13-17; 14 and 15; 14 and 16; 14-16; 14 and 17; 14-17; 15 and 16; 15 and 17; 15-17; and 16 and 17.

To facilitate a better understanding of the embodiments of the present invention, the following examples of preferred or representative embodiments are given. In no way should the following examples be read to limit, or to define, the scope of the invention.

### Examples

In the following examples, polymer particles produced by melt emulsification of polyamide 12 were used. More specifically, melt emulsification was performed using 30,000 cSt PDMS, polyamide 12, and 0.35 wt % AEROSIL® R812S silica nanoparticles by mass of the polyamide 12. In the following examples, these particles are referred to as polyamide particles. The polyamide particles had a D₅₀ of 45.5 μm and a geometric standard deviation of 1.393. Unless otherwise specified, parts in the following examples refer to parts by weight.

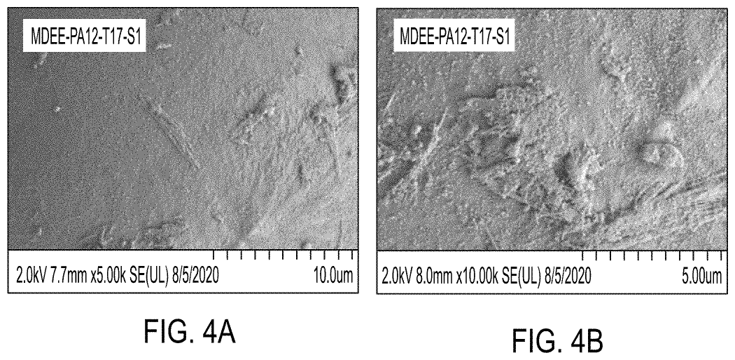

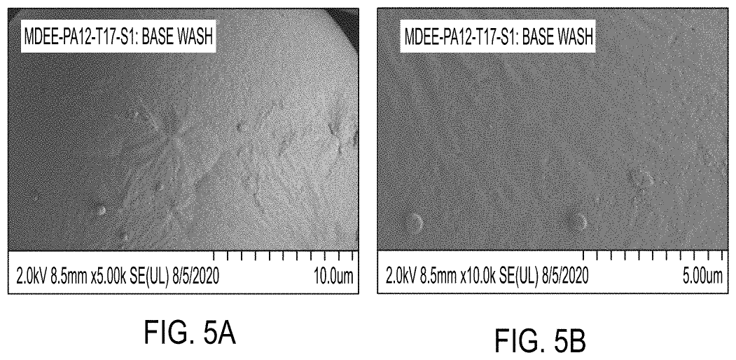

Example 1. The polyamide particles were first treated to remove a substantial amount of the silica from the particle surfaces. First, 5 parts of the polyamide particles were added into 30 parts of 10% (w/w) sodium hydroxide aqueous solution. The slurry was then stirred at 60° C. for 15 minutes and filtered to collect the polyamide particles, followed by rising with deionized water and methanol. The resultant post-treated polyamide particles were dried in a fume hood overnight. FIGS. 4A and 4B are scanning electron microscopy (SEM) images of untreated polyamide particles. FIGS. 5A and 5B are SEM images of post-treated polyamide particles. Comparison of these images showed removal of a substantial amount of the silica nanoparticles from the surface of the polyamide particles.

Example 2. 160 g of post-treated polyamide particles from Example 1 were mixed with 300 parts of graphene oxide dispersion (containing 0.2 mg graphene oxide/mL in water) with stirring for about three minutes. After exposure to the graphene oxide, the polyamide particles were collected by filtration and air-dried. The resultant particles were then re-dispersed in 300 parts of 0.2 M NaH₂PO₂ solution and mixed for about 5 minutes to reduce the graphene oxide to rGO (reduced graphene oxide). The resultant particles were collected by filtration and air-dried. The graphene oxide deposition and reduction operations may be repeated.

Example 3. Using a SnowWhite Sharebot SLS printer, 30 mm×30 mm, single-layer consolidated polymer bodies (referred to in the examples as coupons) were printed using the rGO-coated polyamide particles of Example 2. For SLS printing, the temperature set point was about 138° C., the laser scan rate was about 45,000 points/second (may be converted to scan speed by multiplying by 0.06 mm/point), and the laser power was about 50% to about 70%.

Example 4. A coupon printed per Example 3 with 60% laser power was immersed in a palladium solution (1.5 mM PdCl₂) for 10 seconds and then dried in a fume hood. The dried coupon was then immersed in 0.2 M NaH₂PO₂ solution for 10 seconds and dried in a fume hood. The palladium deposition and reduction operations may be repeated.

Thereafter, the resultant dried coupon was immersed in 0.2 M NaH₂PO₂ solution for 7 minutes and then transferred to a nickel bath (0.2 M sodium citrate, 0.5 M boric acid, 15 g/L nickel (II) sulfate hexahydrate, and 25 g/L sodium hypophosphite monohydrate) at 60° C. for 8 minutes. The resultant metallized coupon was rinsed with deionized water and air-dried.

Example 5. A coupon printed in the same manner as Example 3 with 50% laser power but with post-treated polyamide particles from Example 1 (i.e., particles not having the rGO coating thereon) was immersed in 0.2 mg/L graphene oxide dispersion for 1 minute and then dried in a fume hood. The coupon was then immersed in a 0.2 M NaH₂PO₂ solution for 1 minute and dried to form a rGO coating on the coupon.

The rGO-coated coupon was then subjected to electroless plating conditions as described in Example 4.

Example 6 (Comparative). A coupon lacking rGO was printed in the same manner as Example 3 with 50% laser power but with post-treated polyamide particles from Example 1 (i.e., particles not having the rGO coating thereon) and then subjected to electroless plating conditions as described in Example 4 but without further deposition of rGO thereon.

Example 7. The electrical conductivity of the coupons obtained in Examples 4-6 were measured using a four-point probe technique. The sheet resistance values are provided in Table 1.

TABLE 1

| Coupon | | Sheet Resistance |
|---|---|---|
| Example | Coupon Preparation Summary | (Ω/) |
| 4 | 1) SLS print rGO-coated polymer | 31.7 |
| | particles to produce coupon | |
| | 2) deposit nickel via electroless | |
| | plating | |
| 5 | 1) SLS print particles to produce | 8.61 |
| | coupon lacking rGO coating | |
| | 2) rGO coat coupon | |
| | 3) deposit nickel via electroless | |
| | plating | |
| 6 | 1) SLS print polymer particles to | not detectable |
| (comparative) | produce coupon lacking rGO coating | |
| | 2) deposit nickel via electroless | |
| | plating | |

As shown in Table 1, electroless plating in the presence of two-dimensional conductive nanoparticles provided high conductivity, which indicates a more continuous metal coating. Without the two-dimensional conductive nanoparticles, poor metallization and low conductivity resulted.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. An article comprising:
a polymer body; and
a metal coating on at least a portion of an outer surface of the polymer body, the metal coating comprising a plating metal and overlaying a plurality of two-dimensional conductive nanoparticles and a catalyst metal.

2. The article of claim 1, wherein the plurality of two-dimensional conductive nanoparticles comprise a nanoparticle selected from the group consisting of graphene, reduced graphene oxide, a two-dimensional transition metal carbide, and any combination thereof.

3. The article of claim 1, wherein the plurality of two-dimensional conductive nanoparticle comprises a MXene having a layered structure selected from the group consisting of a transition metal carbide, a transition metal nitride, a transition metal carbonitride, and any combination thereof.

4. The article of claim 1, further comprising:
an adhesion promoter interposed between the outer surface of the polymer body and the two-dimensional conductive nanoparticles.

5. The article of claim 1, wherein the metal coating has a thickness of about 1 micron to about 50 microns.

6. The article of claim 1, wherein the catalyst metal comprises at least one of copper, silver, platinum, or palladium.

7. The article of claim 1, wherein the plating metal comprises at least one of copper, silver, gold, chromium, nickel, or any alloy thereof.

8. The article of claim 1, wherein at least a portion of the plurality of two-dimensional conductive nanoparticles is localized at an interface of the metal coating and the outer surface of the polymer body.

9. The article of claim 1, wherein the polymer body is an additively manufactured polymer body produced by consolidation of polymer particles comprising a thermoplastic polymer.

10. A method comprising:
providing polymer particles comprising a thermoplastic polymer;
wherein the polymer particles have a plurality of two-dimensional conductive nanoparticles deposited as a coating upon an outer surface thereof;
depositing the polymer particles in a powder bed;
consolidating at least a portion of the polymer particles in the powder bed to form a polymer body, in which at least a portion of the two-dimensional conductive nanoparticles are exposed at an outer surface of the polymer body;
depositing a catalyst metal upon an outer surface of the polymer body; and
performing electroless plating upon the outer surface of the polymer body using a plating metal precursor to form a metal coating upon the outer surface of the polymer body, the metal coating comprising a plating metal and overlaying the plurality of two-dimensional conductive nanoparticles and the catalyst metal.

11. The method of claim 10, wherein depositing the catalyst metal upon the outer surface of the polymer body comprises
contacting the polymer body with a catalyst metal precursor and a first reducing agent, and performing electroless plating comprises reducing the plating metal precursor with a second reducing agent, the second reducing agent being the same as or different than the first reducing agent.

12. The method of claim 10, wherein the plurality of two-dimensional conductive nanoparticles comprise a nanoparticle selected from the group consisting of graphene, reduced graphene oxide, a two-dimensional transition metal carbide, and any combination thereof.

13. The method of claim 10, wherein the plurality of two-dimensional conductive nanoparticle comprises a MXene having a layered structure selected from the group consisting of a transition metal carbide, a transition metal nitride, a transition metal carbonitride, and any combination thereof.

14. The method of claim 10, wherein an adhesion promoter is interposed between the outer surface of the polymer body and the two-dimensional conductive nanoparticles.

15. (canceled)

16. (canceled)

17. The method of claim 10, wherein providing polymer particles comprises
depositing the plurality of two-dimensional conductive nanoparticles upon a plurality of thermoplastic polymer particles lacking a surface coating before depositing the plurality of two-dimensional conductive nanoparticles thereon.

18. (canceled)

19. (canceled)

20. The method of claim 10, wherein the plating metal comprises at least one of copper, silver, gold, chromium, nickel, or any alloy thereof.

21. The method of claim 10, further comprising:
performing electroplating upon the metal coating deposited by electroless plating upon the outer surface of the polymer body.

22. The method of claim 10, further comprising:
depositing additional two-dimensional conductive nanoparticles upon the polymer body after formation thereof.

23. The method of claim 10, wherein the polymer particles are formed by melt emulsification and the plurality of two-dimensional conductive nanoparticles are then deposited thereon.
